(19) United States
(12) Patent Application Publication
(10) Pub. No.: US 2004/0162017 A1
(43) Pub. Date: Aug. 19, 2004

(54) Chamber ventilation device

(76) Inventors: Israel Pe'er, Rishon Lezion (IL); Shmuel Orenbuch, Nof Ayalon (IL); Zvi Waldman, Jerusalem (IL)

Correspondence Address: KOHN & ASSOCIATES, PLLC, Suite 410, 30500 Northwestern Highway, Farmington Hills, MI, 48334, US

(21) Appl. No.: 10/406,981

(22) Filed: Apr. 4, 2003

Related U.S. Application Data
(60) Provisional application No. 60/447,993, filed on Feb. 18, 2003.

(51) Int. Cl. B60J 1/20

(52) U.S. Cl. 454/131

(57) ABSTRACT

A chamber ventilation device including an atmospheric pressure mechanism for creating a higher atmospheric pressure environment within an enclosed chamber and a filtering mechanism for filtering air from the outside and surrounding the enclosed chamber. A vehicle ventilation device that includes an atmospheric pressure mechanism and a filtering mechanism.

### CROSS REFERENCE TO RELATED APPLICATIONS

This patent application claims the benefit priority of U.S. Provisional Application No. 60/447,993, filed Feb. 18, 2003, which is incorporated herein by reference.

### BACKGROUND OF THE INVENTION

1. Technical Field

The present invention relates to ventilation devices and more specifically, the ventilation devices for regulating atmospheric conditions within an enclosed chamber and converting the chamber into a protected space in a hazardous environment.

2. Background Art

In hazardous environments where harmful agents such as toxic chemicals, vapors, biological or chemical warfare agents, and the like are present, individuals located within an enclosed chamber, such as a vehicle, can be easily exposed to those harmful agents. Moreover, in such situations, the hazardous environment can exist for extended periods of time. Therefore, the risk of exposure can last for a long period of time and the hazardous environment can be contagious for the same long period of time.

Exposure to a hazardous environment occurs because the chamber is not an airtight or completely sealed enclosure; instead, the chamber includes numerous cracks, air vents, and spaces that allow air to flow to and from the interior of the chamber to the exterior of the chamber where the harmful agents exist. For example, in a vehicle, merely turning off and/or shutting down vehicle registers and/or vents do not insure or prevent airflow between the interior and exterior environments.

In addition to the chamber not being a completely sealed enclosure, atmospheric pressure forces the exterior air to enter the interior of the chamber. Like all fluids, air exerts a pressure on everything within and around it. Pressure is a force exerted on a surface per unit area. Air flows from regions of high atmosphere pressure to regions of low atmospheric pressure. In a high-pressure system, air pressure is greater than the surrounding areas. This difference in air pressure results in moving air. In a high-pressure area, air is denser than in areas of lower pressure. The result is that air will move from the high-pressure area to an area of lower density, or lower pressure. Conversely, moving air tends to blow into low-pressure areas because air moves from areas of higher pressure into areas of lower pressure.

As is well known to those of skill in the art and under natural law, air will travel and move from a higher atmospheric pressure area to one of lesser atmospheric pressure. As a result of the air movement, any other substances in the air will travel and move also. A greater or higher atmospheric pressure at the exterior of the chamber causes air to flow into the chamber, which results in delivering harmful agents into the chamber. Even if the atmospheric pressure is equalized, the possibility of harmful agents entering the chamber exists.

Therefore, in light of the above, there is a need for a device that creates and maintains an interior chamber environment with a higher or positive atmospheric pressure than the exterior environment of the chamber. As a result, the higher or positive atmospheric pressure environment of the interior of the chamber discourages and/or prevents harmful agents from entering the interior of the chamber. Hence, the individuals within the chamber are prevented from being exposed to or contaminated by harmful agents existing in the exterior environment of the chamber.

### SUMMARY OF THE INVENTION

The present invention provides for a chamber ventilation device including an atmospheric pressure mechanism for creating a higher atmospheric pressure environment within an enclosed chamber and a filtering mechanism for filtering air into the chamber obtained from outside the enclosed chamber. The present invention also provides for a vehicle ventilation device including an atmospheric pressure mechanism and a filtering mechanism. The present invention prevents influx of any harmful agents carried by the air from the outside and surrounding the enclosed chamber. Further, the present invention is capable of converting an enclosed chamber into a protected space, wherein a hazardous or harmful environment or situation exists.

### DESCRIPTION OF THE DRAWINGS

Other advantages of the present invention are readily appreciated as the same becomes better understood by reference to the following detailed description when considered in connection with the accompanying drawings wherein:

FIG. 1 is a drawing of one embodiment of chamber ventilation device of the present invention;

FIG. 2 is a drawing of one embodiment of a chamber ventilation device situated in a partially opened window of a vehicle;

FIG. 3 is a drawing of one embodiment of an atmospheric pressure mechanism of the present invention; and

FIG. 4 is a drawing of another embodiment of the chamber ventilation device, wherein the filtering mechanism is removable and replaceable;

FIG. 5 is an illustration of another embodiment of the chamber ventilation device utilized in conjunction with a vehicle window, wherein chamber ventilation device is streamlined, compact, and forms a tight seal around the partial opening of the window of the vehicle;

FIG. 6 is an illustration of an embodiment of the chamber ventilation device utilized in a sliding window of a room or chamber;

FIG. 7 is an illustration of placement of the chamber ventilation device in a partially opened window of a room or chamber, wherein the filtering mechanism and atmospheric pressure mechanism are situated within the room or chamber; and

FIG. 8 is an illustration of an embodiment of the chamber ventilation device situated within a partially opened window of a room or chamber.

### DETAILED DESCRIPTION OF THE INVENTION

Generally, the present invention is a chamber ventilation device that is capable of creating and maintaining a higher atmospheric pressure within a chamber. In other words, the interior chamber atmospheric pressure is created and maintained above the exterior or outside atmospheric pressure surrounding the chamber. As a result, harmful agents cannot enter or flow into the interior of the chamber.

The present invention has numerous advantages over the prior art. For instance, the present invention is capable of providing uncontaminated air within an enclosed chamber. More importantly, the present invention is capable of creating and/or maintaining an interior environment that has a positive or higher atmospheric pressure as compared to the environment outside of the enclosed chamber. By maintaining the higher pressure within the enclosed chamber, any possible leaks and/or openings that cannot be completely sealed will not be capable of allowing contaminated air from the environment to enter the enclosed chamber. Additionally, with the present invention, clean, filtered air can be drawn into the interior of the chamber. As a result, the concentration of any existing harmful agents within the chamber will be diluted with the clean, filtered air drawn into the chamber.

The term “harmful agents” as used herein includes, but is not limited to, biological agents such as anthrax, various germs and viruses, chemical agents such as mustard gas, caustic agents, and any other agent that can cause illness, disease, and/or death to a living being. The harmful agents can be in vapor, gaseous, liquid, or solid form.

The term “hazardous environment” as used herein includes, but is not limited to, an environment containing any amount of harmful agents. The hazardous environment is the exterior or outside of the chamber. The hazardous environment is the outside or exterior atmosphere surrounding the chamber.

The term “chamber” as used herein means a natural or artificial enclosed space or cavity, which includes, but is not limited to, a vehicle, rooms, tents, closets, and any other similar enclosed space or area known to those of skill in the art. Furthermore, examples of vehicles include, but are not limited to, a car, automobile, bus, truck, van, boats, recreational vehicles, and any other similar vehicle known to those of skill in the art. Typically, the chamber includes walls defining the enclosed space.

The term “opening” as used herein means an open place or part, hole, gap, aperture, and the like. The opening includes edges that define the size of the opening. The opening is located on any part of the chamber. Typically, the opening is on an outer wall of the chamber.

The term “higher atmospheric pressure” or “positive atmospheric pressure” means, but is not limited to, an area of air that has greater air pressure that causes the air, and any substances in the air, to move. Specifically, the air will move to an area that has either a lower atmospheric pressure or a negative atmospheric pressure.

The term “power source” as used herein includes, but is not limited to, electrical power outlets of any voltage, dc power outlet (i.e., cigarette lighter), ac power outlet, solar cells, batteries, and any other similar power source known to those of skill in the art. Additionally, the power source can also include a battery or hand operated back-up system.

The present invention has numerous embodiments. In one embodiment, the present invention is a chamber ventilation device 10 including an atmospheric pressure mechanism 12 for creating a higher atmospheric pressure environment within an enclosed chamber, which prevents influx of any air and/or harmful agents situated in the exterior or outside of the enclosed chamber.

The atmospheric pressure mechanism 12 can be any device that is capable of creating a higher atmospheric pressure environment within the chamber. For example, the atmospheric pressure mechanism 12 can be a fan, blower, or other vacuum system that draws in or forces air from the outside environment of the chamber into the interior of the chamber. Further, the atmospheric pressure mechanism 12 can be powered by any power source as defined above and can optionally include a battery back up with or without an external source of power. A cord 11 or cable 11 can be attached to the atmospheric pressure mechanism 12 to connect to the power source.

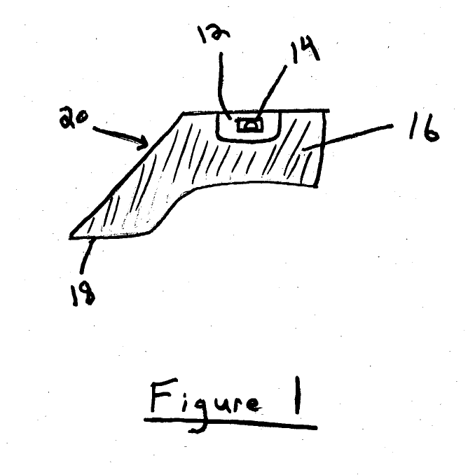

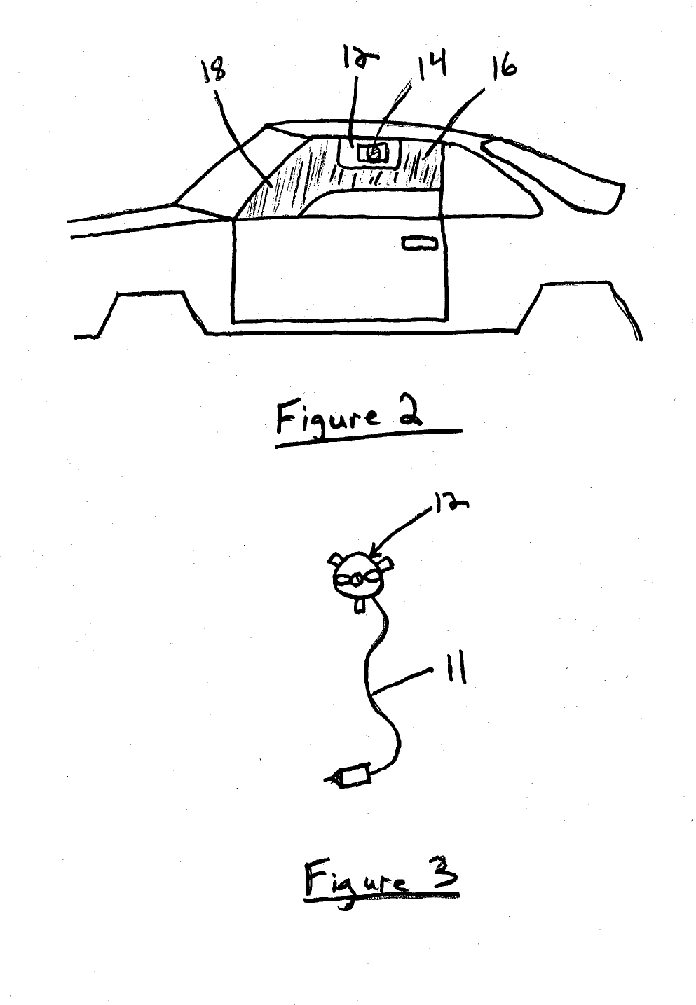

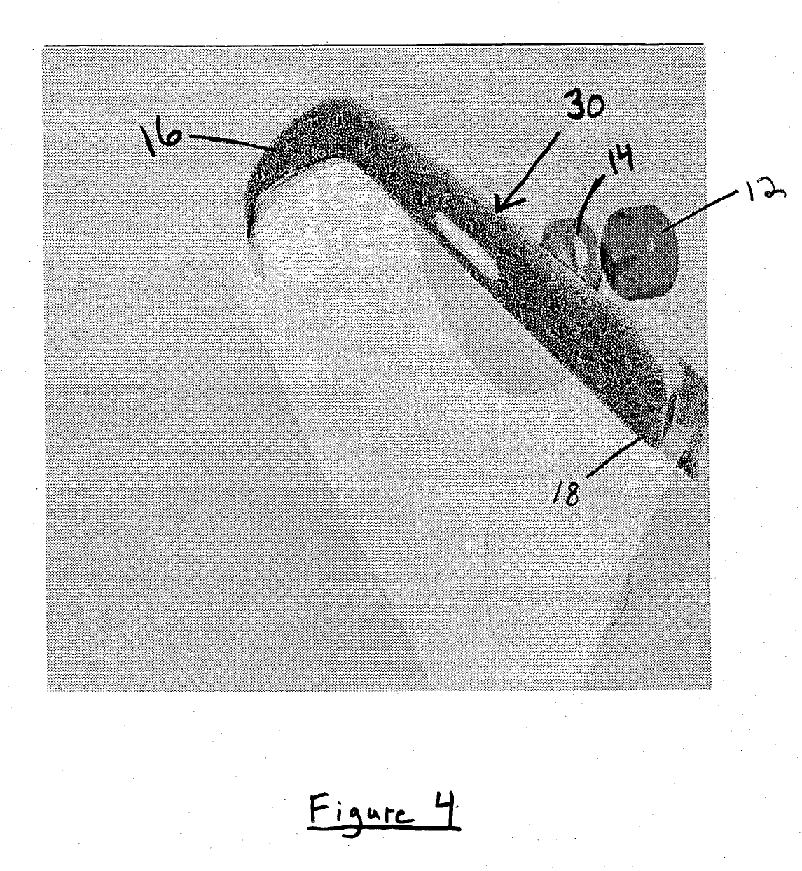

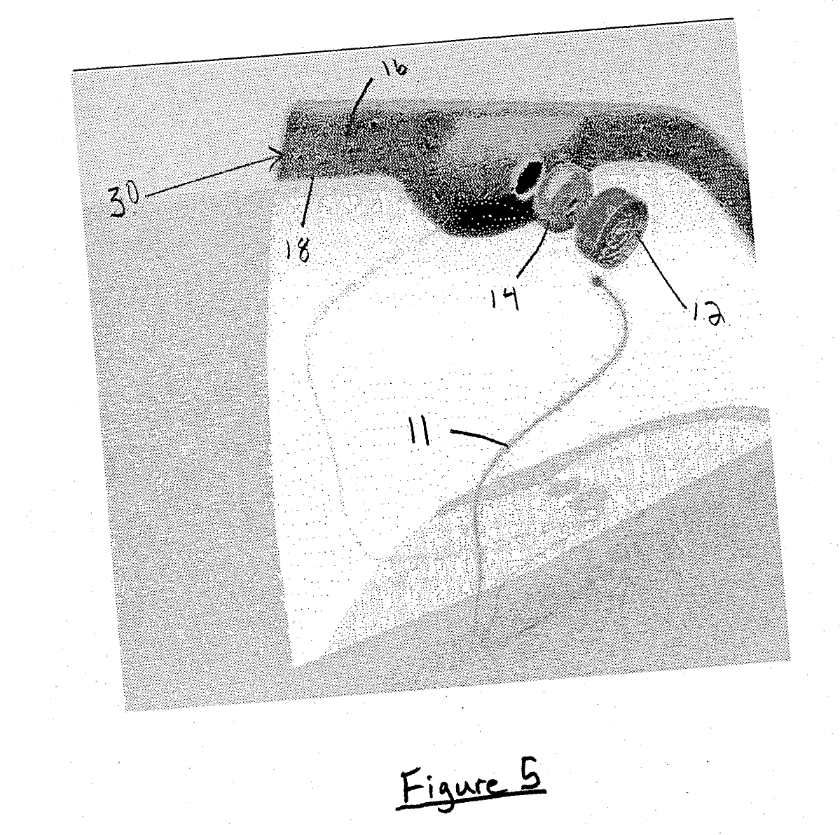

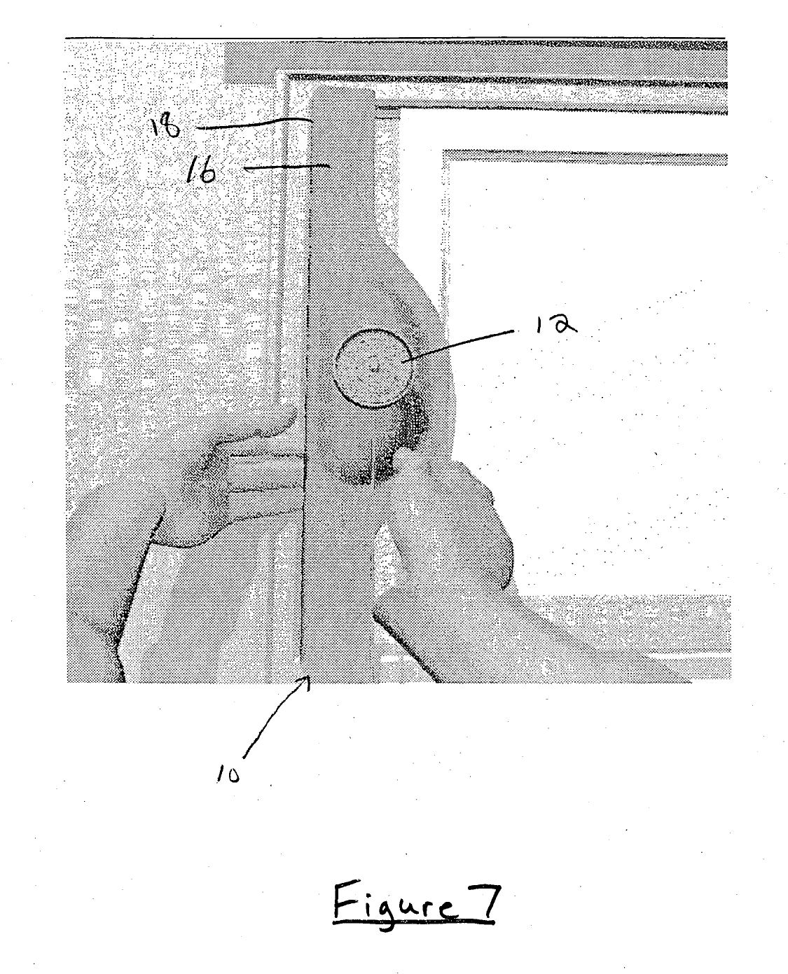

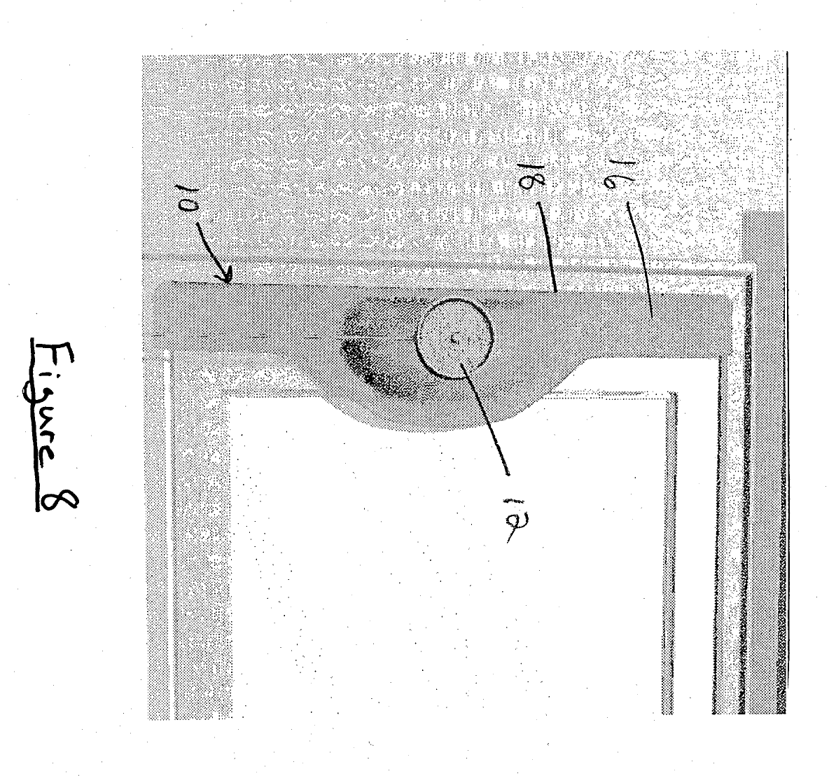

By bringing in outside air, the air must be filtered. Filtering can be accomplished utilizing a filtering mechanism 14. The filtering mechanism 14 is any device capable of filtering and removing harmful agents from the air. Specifically, the filtering mechanism 14 is at least one filter, but can be multiple filters placed next to each other or in a series. The filtering mechanism 14 can have various shapes and configurations that include being smooth, rough, tapered, ridged, and/or recessed. Further, the filtering mechanism 14 can be located in any position. In one embodiment, the filtering mechanism 14 is on the exterior of the chamber so that the atmospheric pressure mechanism 12 draws the exterior air through the filtering mechanism 14 and into the interior of the chamber (FIGS. 1 and 3). However, the filtering mechanism 14 can be located within the chamber also (FIGS. 4 to 8).

Numerous filtering mechanisms 14 are known to those of skill in the art. The filtering mechanism can be a filter including, but not limited to, glass fiber, carbon filter, cotton fiber filter, solid chemical filtration media such as those used with gas masks, activated charcoal, silica gel, liquid filter media, water filter medium, combinations thereof, and any other similar filtering mechanisms capable of filtering harmful substances known to those of skill in the art. The filtering mechanism 14 can be removable, replaceable, and/or reusable. Once the filtered air is drawn into the interior of the chamber, a higher atmospheric pressure environment is created. As a result, airflow will be from the interior of the chamber to the exterior of the chamber. Therefore, regardless of any openings, aside from the opening in which the chamber ventilation system is placed, harmful agents cannot enter the chamber.

The chamber ventilation device 10 further includes adapting structure mechanisms 16 for secure and snug placement within an opening of the chamber. The adapting structure mechanisms 16 include, but are not limited to, impermeable panels 16, impermeable plates 16, impermeable membranes 16, mesh, grids, and the like. The adapting structure mechanisms 16 snugly receive the edges of the opening and are held in place in on the edge via securing mechanisms such as clips, screws, bolts, fasteners, snaps, and any other similar securing mechanisms known to those of skill in the art. The securing mechanisms can be made of any materials such as plastic, metal, combinations, and the like.

A sealing mechanism 18 can be attached to the outer portion of the adapting structure mechanisms 16 to enable a tight engagement and/or seal between the adapting structures 16 and opening frame of the chamber. The sealing mechanism 18 can be made of any materials including, but not limited to, rubber, silicon, wax, alloys, soft metals, combinations thereof, and any other similar sealing materials known to those of skill in the art.

In another embodiment, the present invention is a vehicle ventilation device 20 including an atmospheric pressure mechanism 12 for creating a higher atmospheric pressure environment within an enclosed vehicle. Again, the atmospheric pressure mechanism 12 can be any device that is capable of creating a higher atmospheric pressure environment within the vehicle. The atmospheric pressure mechanism 12 has been described above.

The vehicle ventilation device 20 also includes a filtering mechanism 14. The filtering mechanism 14 is any device capable of filtering and removing harmful agents from the air. A more detailed description of the filtering mechanism 14 is set forth above.

Additionally, the vehicle ventilation device 10 includes adapting structure mechanisms 16 for secure and snug placement within an opening of the vehicle. Specifically, the opening of the vehicle is a partially or completely opened window. Further, the opened window forms window opening frame defined by a windowpane and the edges of the window frame corresponding to the vehicle door and/or vehicle body. The adapting structure mechanisms 16 include, but are not limited to, impermeable panels 16, impermeable plates 16, impermeable membranes 16, and the like. The adapting structure mechanisms 16 snugly engage and receive the edge of the windowpane, preferably in a passive manner. The adapting structure mechanisms 16 also snugly engage the edges of the window frame corresponding to the vehicle door and/or vehicle body. Preferably, the adapting structure mechanisms 16 actively engage the edges of window frame corresponding to the vehicle door or vehicle body. The adapting structure mechanisms 16 further include securing mechanisms including, but not limited to, clips, screws, bolts, fasteners, snaps, and any other similar securing parts known to those of skill in the art. The securing mechanisms can be made of any materials such as plastic, metal, combinations thereof, and the like.

A sealing mechanism 18 can be attached to the outer portion of the adapting structure mechanisms 16 to enable a tight engagement and/or seal between the adapting structure mechanisms 16 and window frame of the vehicle. The sealing mechanism 18 can be made of any materials including, but not limited to, rubber, silicon, wax, alloys, soft metals, combinations thereof, and any other similar sealing materials known to those of skill in the art. The sealing occurs either passively or actively with the edge of the windowpane and/or the window frame corresponding to the vehicle door and/or vehicle body.

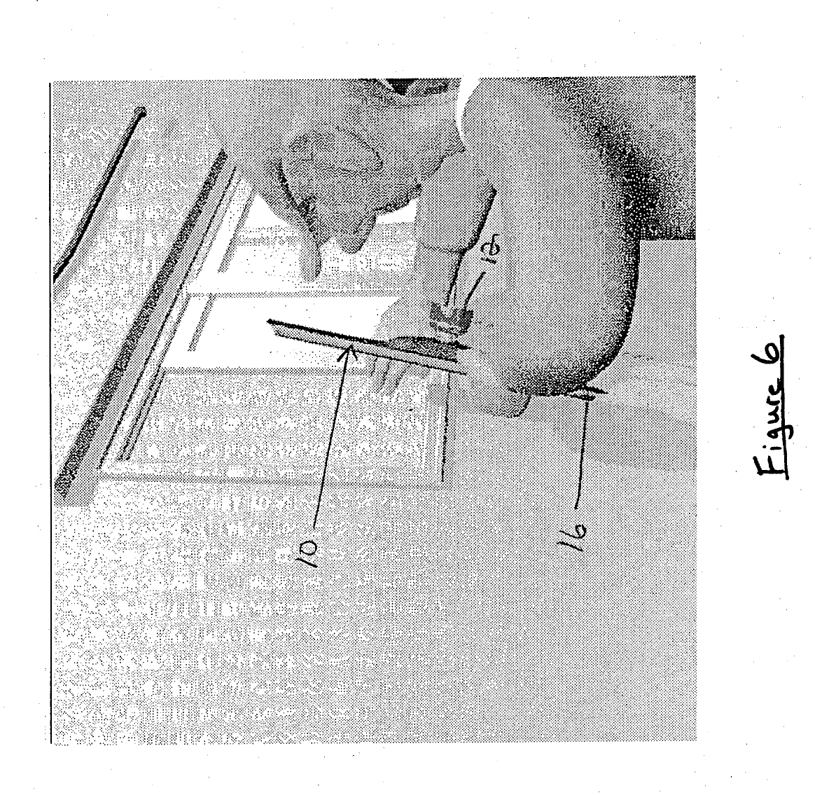

In another embodiment, the present invention is a vehicle ventilation device 30 that is a single, uniform device that is streamline and compact. The vehicle ventilation device 30 includes the same components as set forth above. The filtering mechanism 14 is disposable and replaceable. Further, the filtering mechanism 14 and the atmospheric pressure mechanism 12 are located within the vehicle (FIGS. 4 and 5).

The present invention can be made through various methods known to those of skill in the art. All of the parts of the present invention exist and are well known to those of skill in the art. Moreover, assembly of the parts of the present invention can be accomplished by those of skill in the art.

The present invention can be utilized in a variety of settings, including, but not limited to, houses, apartments, buildings, vehicles, and any enclosed chamber know to those of skill in the art. The present invention is particularly suited for use when the environment outside of the chamber is hazardous and/or toxic to the occupants of the chamber. Moreover, the present invention is transportable. Thus, the present invention can be moved from one location to another where individuals are located or where the either the chamber ventilation or vehicle ventilation device is needed. Additionally, since the present invention can be powered by any available means, it can be easily moved and adapted to be used in any setting.

Throughout this application, various publications, including U.S. patents that are referenced by author and year, and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Obviously, many modifications and variations of the present invention are possible in light of the above teachings. It is, therefore, to be understood that within the scope of the appended claims, the invention can be practiced otherwise than as specifically described.

What is claimed is:

1. A chamber ventilation device comprising:
atmospheric pressure means for creating a higher atmospheric pressure
environment within an enclosed chamber; and
filtering means for filtering air into the chamber from outside of the
enclosed chamber.

2. The chamber ventilation device according to claim 1, wherein said atmospheric pressure means is selected from the group consisting of a fan, blower, and vacuum system that draws in or forces air from outside of the chamber into the chamber.

3. The chamber ventilation device according to claim 1, wherein said atmospheric pressure means is powered by power source selected from the group consisting of electrical power outlets of any voltage, dc power outlet, ac power outlet, solar cells, batteries, manual operation, and any other similar power source known to those of skill in the art.

4. The chamber ventilation device according to claim 1, wherein said filtering means includes at least one filter selected from the group consisting of glass fiber, carbon filter, cotton fiber filter, solid chemical filtration media such as those used with gas masks, activated charcoal, silica gel, liquid filter media, water filter medium, and combinations thereof.

5. The chamber ventilation device according to claim 4, wherein said filter is removable and replaceable.

6. The chamber ventilation device according to claim 1, further comprising adapting structure means for securing and placing the chamber ventilation device in an opening of the chamber.

7. The chamber ventilation device according to claim 6, wherein said adapting structure means is selected from the group consisting of impermeable panels, impermeable plates, impermeable membranes, grids, mesh, and combinations thereof.

8. The chamber ventilation device according to claim 7, wherein said adapting structure means further includes securing means for securing and removably fixing the adapting structure means to the opening, said securing means is selected from the group consisting of metal or plastic clips, screws, fasteners, snaps, and combinations thereof.

9. The chamber ventilation device according to claim 8, wherein said adapting structure means further includes sealing means for sealing and creating a tight engagement and seal between adapting structure means and edges of the opening located in the chamber, wherein said sealing means is selected from the group consisting of rubber, silicon, soft metals, alloys, polymers, plastics, wax, and combinations thereof.

10. The chamber ventilation device according to claim 1, wherein said chamber ventilation device is removable and reusable.

11. A vehicle ventilation device comprising:
atmospheric pressure means for creating a higher atmospheric pressure
environment within an enclosed vehicle; and
filtering means for filtering air into the vehicle from outside of the enclosed
vehicle.

12. The vehicle ventilation device according to claim 11, wherein said atmospheric pressure means is selected from the group consisting of a fan, blower, and vacuum system that draws in or forces air from the outside environment of the vehicle into the vehicle.

13. The vehicle ventilation device according to claim 11, wherein said atmospheric pressure means is powered by power source selected from the group consisting of electrical power outlets of any voltage, dc power outlet, ac power outlet, solar cells, batteries, manual operation, and any other similar power source known to those of skill in the art.

14. The vehicle ventilation device according to claim 11, wherein said filtering means includes at least one filter selected from the group consisting of glass fiber, carbon filter, cotton fiber filter, solid chemical filtration media such as those used with gas masks, activated charcoal, silica gel, liquid filter media, water filter medium, and combinations thereof.

15. The vehicle ventilation device according to claim 14, wherein said filter is removable and replaceable.

16. The vehicle ventilation device according to claim 11, further comprising adapting structure means for securing and placing the vehicle ventilation device in an opened window of the vehicle, wherein the opened window has a window frame defined by an edge of a window pane and the edges of the window frame corresponding to the vehicle door or vehicle body.

17. The vehicle ventilation device according to claim 16, wherein said adapting structure means is selected from the group consisting of impermeable panels, impermeable plates, impermeable membranes, grids, mesh, and combinations thereof.

18. The vehicle ventilation device according to claim 17, wherein said adapting structure means further includes securing means for securing and removably fixing the adapting structure means to the opened window, said securing means are selected from the group consisting of metal or plastic clips, screws, bolts, fasteners, snaps, and combinations thereof.

19. The vehicle ventilation device according to claim 18, wherein said adapting structure means further includes sealing means for sealing and creating a tight engagement and seal between adapting structure means and edges of the opening located in the vehicle, wherein said sealing means is selected from the group consisting of rubber, silicon, polymers, plastics, alloys, waxes, and combinations thereof.

20. The vehicle ventilation device according to claim 19, wherein said adapting structure means passively engages the edge of the window pane and actively engages the edges of the window frame corresponding to the vehicle door or vehicle body.

21. The vehicle ventilation device according to claim 11, wherein said vehicle ventilation device is removable and reusable.
